(19) United States
(12) Patent Application Publication
(10) Pub. No.: US 2008/0147370 A1
(43) Pub. Date: Jun. 19, 2008

(54) Method and System of Retransmission

(75) Inventor: Klas Sjerling, Bromma (SE)

Correspondence Address: ERICSSON INC., 6300 LEGACY DRIVE, M/S EVR 1-C-11, PLANO, TX, 75024, US

(73) Assignee: Telefonaktiebolabet LM Ericsson (publ), Stockholm (SE)

(21) Appl. No.: 11/816,114

(22) PCT Filed: Feb. 13, 2005
(86) PCT No.: PCT/SE05/00190

§ 371 Date: Aug. 13, 2007

(51) Int. Cl. H04L 12/26; G06F 17/50

(52) U.S. Cl. 703/13; 370/252

(57) ABSTRACT

The present invention relates to uplink testing of a base station of a mobile communications system. Message blocks are sent each with a predefined maximum number of retransmissions from a mobile station emulator or simulator for each message block of the test without requiring one or more retransmission requests from the base station under test. The invention is well suited for a cellular mobile radio communications system, particularly a Universal Mobile Telecommunications System, UMTS.

### TECHNICAL FIELD OF THE INVENTION

The present invention relates to transmissions verification in a communications system, and more especially it relates to verification of equipment of a cellular mobile radio system, particularly of a Universal Mobile Telecommunications System, UMTS or WCDMA system.

### BACKGROUND AND DESCRIPTION OF RELATED ART

Retransmission of data to or from a mobile station, MS, or user equipment, UE, is previously known. It is also known to use medium access control and radio link control layers of a UMTS protocol structure in acknowledged mode for dedicated channels.

In acknowledged mode, retransmissions are undertaken in case of detected transmission errors not recovered by forward error control. This is also called automatic repeat request, ARQ. With ARQ, retransmissions can be undertaken unless a transmitted message is (positively) acknowledged or if it is negatively acknowledged. Generally there are time limits for the respective positive and negative acknowledgements to be considered.

FIG. 1 illustrates an example equipment of a radio communications system. Within this patent application, an RNC (Radio Network Controller) [symbol] RNC [symbol] is understood as a network element including a radio resource controller. Node B [symbol] Node B1 [symbol] , [symbol] Node B 2 [symbol] is a logical node responsible for radio transmission/reception in one or more cells to/from a User Equipment [symbol] UE [symbol] . The figure shows uplink and downlink communications directions [symbol] uplink [symbol] , [symbol] downlink [symbol] . A base station, BS, is a physical entity representing Node B [symbol] BS1/Node B 1 [symbol] , [symbol] BS2/Node B 2 [symbol] . RNC is connected with Node B over an Iub interface. In the figure Node B [symbol] Node B1 [symbol] , [symbol] Node B 2 [symbol] and user equipment [symbol] UE [symbol] are illustrated to comprise ARQ entities [symbol] ARQ [symbol] .

Medium access control, MAC, and radio link control, RLC, is used within radio communications systems like General Packet Radio Services, GPRS, and UMTS.

3^{rd} Generation Partnership Project (3GPP): Technical Specification Group Radio Access Network, Physical Layer Procedures, 3G TS 34.121 v5.6.0, France, December 2004, describes in paragraph 9.3.1.4.1 setting of ACK/NACK handling at the SS (System Simulator) such that regardless of the response from the UE (ACK, NACK or DTX) new data is sent each time, this is because HARQ transmissions are set to one, i.e. no re-transmission of failed blocks, for verifying the variance of CQI reports. The system simulator, SS, is a device or system, that is capable of generating simulated Node B signaling and analyzing UE signaling responses on one or more RF channels, in order to create the required test environment for the UE under test. FIG. 2, corresponding to figure A.16 in the 3GPP technical specification, illustrates a connection for multipath fading propagation test according to the specification. The System Simulator produces a transmission, TX, downlink send signal [symbol] S [symbol] at a simulated Node B antenna connector, the downlink sent signal [symbol] S [symbol] being of desired spectral density Iₒᵣ. The downlink sent signal is e.g. a High-Speed Downlink Shared Channel, HS-DSCH. The downlink signal [symbol] S [symbol] is passed through an attenuator [symbol] ATT1 [symbol] and a fading simulator [symbol] Fading Simulator [symbol] to produce a simulated receiver signal [symbol] R [symbol] . An AWGN (Additive White Gaussian Noise) generator [symbol] AWGN Generator [symbol] produces a noise signal [symbol] N [symbol] that is passed through an attenuator [symbol] ATT2 [symbol] to produce a band limited noise signal [symbol] N_{A} [symbol] of desired spectral density I_{oc}. The receiver signal [symbol] R [symbol] and the simulated noise signal [symbol] N [symbol] are combined in a hybrid combiner [symbol] HYB [symbol] . The combined receiver signal and noise [symbol] R+N_{A} [symbol] is input to the antenna connector of the UE under test [symbol] UE under Test [symbol] by passing it through circulator [symbol] C [symbol] . The UE under test [symbol] UE under Test [symbol] transmits, TX, in uplink direction. The uplink signal being passed through a circulator [symbol] C [symbol] or corresponding equipment and an attenuator [symbol] ATT3 [symbol] .

Section 9.2 of the 3GPP technical specification pertains to single link performance of the HS-DSCH in different multipath fading environments. The UE receiver single link performance for the HS-DSCH is determined by the information bit throughput. Table 9.2.1.2. lists prescribed behavior of Node B in response to ACK/NACK/DTX from UE. If an ACK is received a new transmission is initiated. If a NACK is received and not the maximum number of retransmissions is reached a retransmission is initiated. There is a maximum of four transmissions allowed, the transmissions being combined using Hybrid ARQ, HARQ. An Acknowledged Mode Control entity [symbol] AMC [symbol] receives UE measurement reports and retransmits data blocks as need be.

3rd Generation Partnership Project (3GPP): Technical Specification Group Radio Access Network, FDD Enhanced Uplink; Physical Layer Aspects (Release 6), 3G TS 25.808 v1.0.1, France, February 2005, captures support of Node B controlled scheduling, hybrid ARQ and shorter TTI, with regards to the overall support of UTRA FDD Enhanced Uplink. Section 8.1 describes physical channel structure for data transmissions. The E-DPDCH (E-DCH Dedicated Physical Data Channel) is a physical channel on which CCTrCh (Coded Composite Transport Channel) of E-DCH (Enhanced Dedicated Channel) type is mapped. The CCTrCh is a data stream resulting from encoding and multiplexing of one or several transport channels. FIG. 3 illustrates the frame structure of E-DPDCH. The E-DPDCH radio frame is divided into 5 subframes, each of length 2 ms; the first subframe starts at the start of each E-DPDCH radio frame and the 5^{th} sub-frame ends at the end of each E-DPDCH radio frame. Data is transmitted in slots, each slot comprising 2560 chips. The number of data bits [symbol] N_{data} [symbol] depends on the bit rate/SF (Spreading Factor) used according to table 1.

TABLE 1
E-DPDCH slot formats.

| Slot Format | Channel Bit | | Bits/ | Bits/ | Bits/Slot |
|---|---|---|---|---|---|
| #I | Rate (kbps) | SF | Frame | Subframe | N_{data} |
| 0 | 60 | 64 | 600 | 120 | 40 |
| 1 | 120 | 32 | 1200 | 240 | 80 |
| 2 | 240 | 16 | 2400 | 480 | 160 |
| 3 | 480 | 8 | 4800 | 960 | 320 |
| 4 | 960 | 4 | 9600 | 1920 | 640 |
| 5 | 1920 | 2 | 19200 | 3840 | 1280 |

Section 8.2.1 of the 3GPP technical specification specifies E-DCH HARQ Acknowledgement Indicator Channel, E-HICH. E-HICH is a fixed rate (SF=128) downlink physical channel carrying the uplink E-DCH Hybrid-ARQ Acknowledgement, HARQ-ACK, indicator.

3rd Generation Partnership Project (3GPP): Technical Specification Group Radio Access Network, Base Station (BS) radio transmission and reception (FDD) (Release 6), 3G TS 25.104 v6.8.0, France, December 2004, specifies Base Station minimum RF characteristics of the FDD (Frequency Division Duplex) mode of UTRA (Universal Terrestrial Radio Access). Section 8.3 describes four test cases for demodulation of DCH under multipath fading channel conditions. Section B.2 specifies propagation conditions for multipath fading environments.

3^{rd} Generation Partnership Project (3GPP): Technical Specification Group Radio Access Network, Base Station (BS) conformance testing (FDD) (Release 6), 3G TS 25.141 v6.8.0, France, December 2004, specifies the RF (Radio Frequency) test methods and conformance requirements for UTRA Base Stations operating in the FDD mode. The test methods and conformance requirements have been derived from, and are consistent with the UTRA Base Station specifications defined in 3GPP TS 25.104. Section 8.3 specifies procedures for the four test cases for demodulation of DCH under multipath fading channel conditions.

None of the cited documents above discloses a method and system of eliminating or reducing transmissions of status reports of feedback information for test purposes.

### SUMMARY OF THE INVENTION

Cited prior art references describe transmissions between a UE entity and a Node B or a System Simulator.

When involving Hybrid ARQ transmissions, prior art describes either that only one transmission instance of each information block should be allowed or that a dynamic number of transmissions should be initiated depending on feedback information requiring a feedback channel.

Single transmissions cannot simulate performance increase of ARQ due to retransmissions. A dynamic number of trans-missions requires feedback information, which in turn require test equipment to comprise modulation and transmission of such control information to be received at the other end of a simulated channel, e.g. a transmission channel causing multipath fading.

Particularly, for testing of enhanced uplink transmissions it is greatly desired for testing of performance measures such as throughput that only the link under consideration is required in test equipment, not also requiring full implementation of a feedback link to perform required tests.

Consequently, it is an object of this invention to eliminate or reduce transmissions over a feedback channel, while still achieving relevant and reliable test results.

A further object is to eliminate or reduce transmissions over the feedback channel while not introducing processes, which could obscure the causes of e.g. a test not performing according to the requirements.

It is also an object to simplify the test processes to achieve a test simulator capable of speeding up the test processes.

Finally, it is an object to separate various tests to reduce dependencies, which could vary between different running system installations.

These objects are met by the invention, which is particularly well suited for performance tests of enhanced uplink of a system with high-speed downlink packet access of an evolved universal mobile telecommunications system.

Preferred embodiments of the invention, by way of examples, are described with reference to the accompanying drawings below.

### BRIEF DESCRIPTION OF THE DRAWINGS

FIG. 1 illustrates an example equipment of a radio communications system.

FIG. 2 illustrates a connection for multipath fading propagation test according to prior art.

FIG. 3 illustrates the frame structure of E-DPDCH.

FIG. 4 illustrates example test equipment connected for uplink testing according to the invention.

FIG. 5 illustrates in a flowchart an example test procedure for determining base station uplink performance measure according to the invention.

FIG. 6 illustrates a mobile station emulator or simulator according to the invention.

FIG. 7 illustrates example test equipment according to the invention.

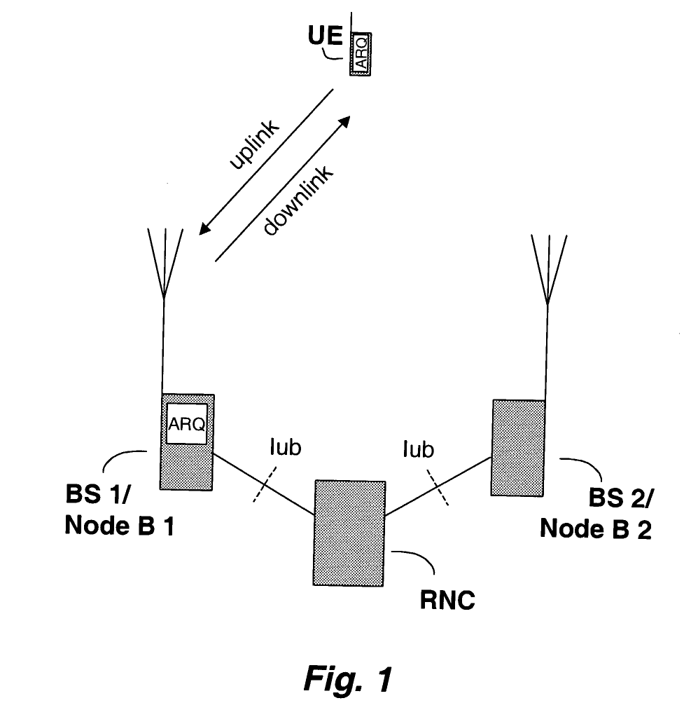

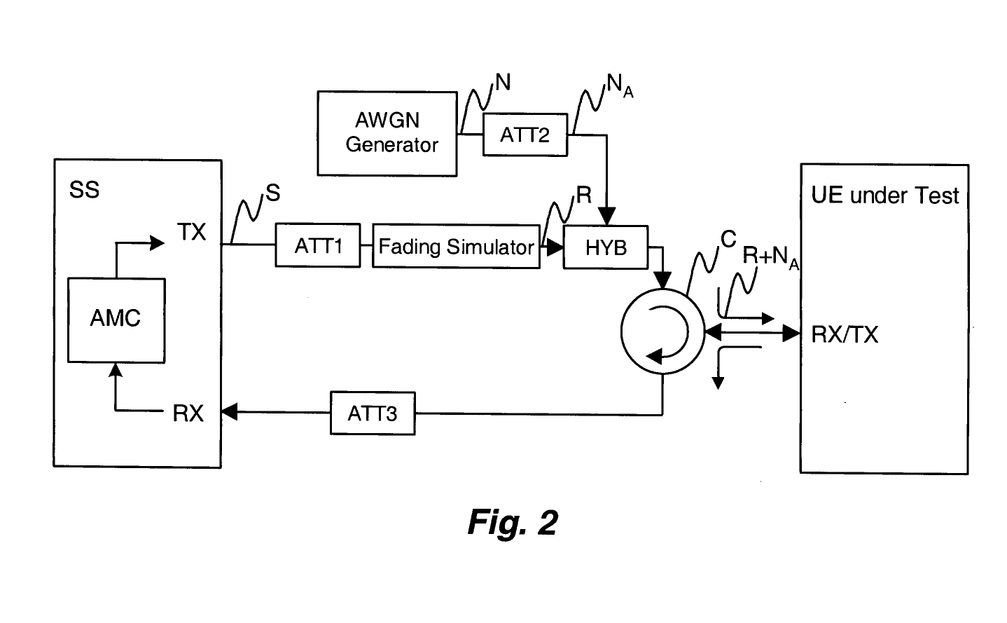

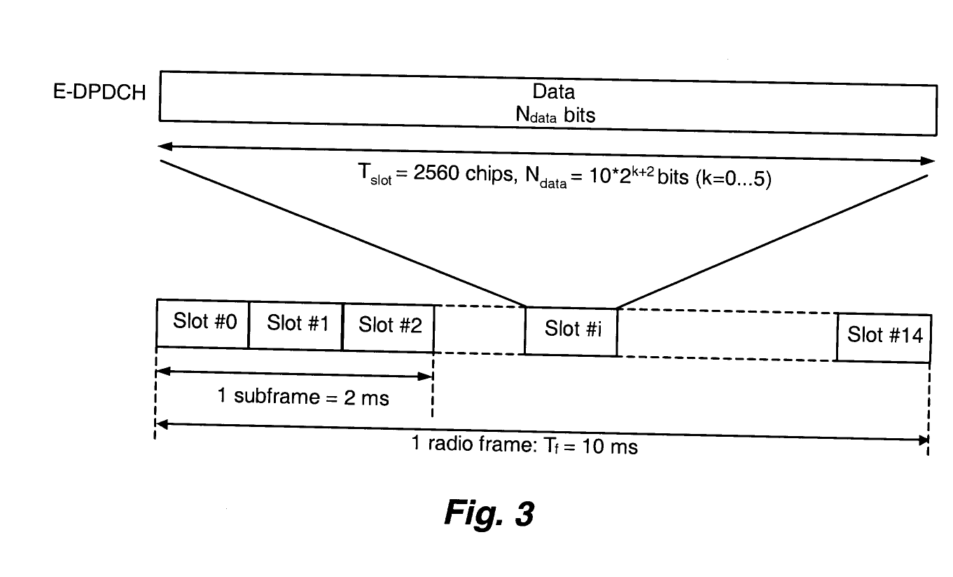

### DESCRIPTION OF PREFERRED EMBODIMENTS

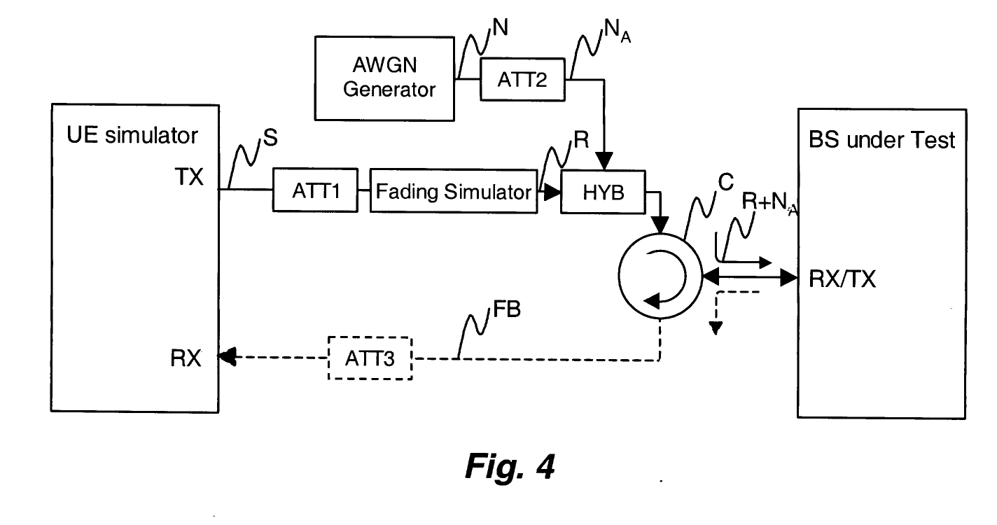

FIG. 4 illustrates example test equipment connected for uplink testing according to the invention. Particularly enhanced uplink of a UMTS system is tested. An important component of increasing bit-rate and capacity of uplink communications is adoption of hybrid ARQ. During performance verification of a base station [symbol] BS under Test [symbol] , a radio channel simulator simulates the varying radio conditions. The radio channel simulator comprises in a preferred embodiment a noise generator [symbol] AWGN Generator [symbol] , attenuators [symbol] ATT1 [symbol] , [symbol] ATT2 [symbol] , a fading simulator [symbol] Fading Simulator [symbol] producing channel variations of desired characteristics affecting a send signal [symbol] S [symbol] from a UE simulator for realistic and relevant uplink testing, and a hybrid combiner [symbol] HYB [symbol] or corresponding equipment for combining a receive signal [symbol] R [symbol] and an attenuated noise signal [symbol] N_{A} [symbol] .

In a real system a feedback signal [symbol] FB [symbol] is sent from the base station [symbol] BS under test [symbol] to a present user equipment entity. The feedback information provides, e.g., HARQ related information for the user equipment to determine whether further transmissions of earlier sent data should be initiated. Obviously retransmissions of data reduces throughput as compared to the case where transmissions are successfully decoded without further (re-)transmissions.

Also a UE simulator of (enhanced) uplink testing could, of course, be made to comprise radio frequency tuners for demodulating feedback information similar to a real UE. However, for test purposes this would increase costs of the test equipment and it would introduce difficulties determining base station uplink circuitry impact on, e.g., the resulting (uplink) throughput test results. A fully implemented feedback channel [symbol] FB [symbol] of a test system would require the mobile station, MS, emulator or simulator [symbol] UE simulator [symbol] to decode the radio feedback signal and adjust in real time (i.e. more or less instantaneously) data to be sent [symbol] S [symbol] to the base station [symbol] BS under test [symbol] . Consequently, in addition to demodulation capacity this would require substantial processing capacity of an MS emulator or simulator [symbol] UE simulator [symbol] .

A further advantage of not requiring feedback is that error in the feedback channel can be considered separately without complicated analysis of test results affected by error processes of both enhanced uplink and feedback channel in a joint analysis of enhanced uplink channel and feedback channel stochastic processes.

This advantage is even greater when considering also hand-over processes which may generate errors in sequence numbers of protocol data units combining with errors of a feedback channel and affecting test performance of the base station uplink under test.

It is therefore for uplink test purposes greatly desired to eliminate the feedback path of the test of (enhanced) uplink performance, e.g. throughput.

According to a preferred embodiment of the invention, a reliable test procedure is claimed sending predefined test patterns not requiring feedback. This is achieved by introducing a maximum number of allowed transmissions, corresponding to the maximum number of HARQ transmissions.

According to the invention, the MS emulator or simulator [symbol] UE simulator [symbol] is constructed to send this predefined maximum number of transmissions. These transmissions of each message will be combined by the base station [symbol] BS under Test [symbol] as need be.

The inventor observes that according to, e.g., the 3GPP specifications, a base station should provide an RSN (Retransmission Sequence Number) for each decoded message block. The inventor further observes that the RSN reflects the number of transmissions required until the message block was successfully decoded. (With successful decoding, is understood decoding that according to available error checking appears to be correct. With great likelihood the decoded message block then also is correctly decoded.) Presently, however not limiting the invention, RSN is maximized to three (RSNε[0, 1, 2, 3]), and therefore only requires two bits to be transferred. Throughput is the preferred performance measure. According to a first mode of the invention, the throughput is calculated based upon the ratio of the number of required transmissions as reflected by RSNs, the total number of message block transmissions and the predefined maximum number of (re-)transmissions of each message block, and time spent on each transmission; or equivalently number of initial transmissions of each block, ΣᵢBlockᵢ, and total time spent on required transmissions as reflected by RSNs, Σᵢ(1+RSNᵢ). Transmission efficiency, without considering unsuccessful decoding would then be

$${η}_{1} = \frac{{\sum }_{i} {Block}_{i}}{{\sum }_{i} ( 1 + {RSN}_{i} )} . \qquad ( 1 )$$

A minor drawback of the method according to the invention is a test procedure somewhat extended in time, since time is now and then spent on (re-)transmission of message not required by base station under test [symbol] BS under Test [symbol] .

With the present limit of RSN the test will provide correct results for all maximum number of transmission instances of each message block less than or equal to four (corresponding to an initial transmission and three or less retransmissions). For realistic test purposes, four is a preferred greatest maximum number of transmissions of each message block.

According to the invention there are preferably a plurality of predefined test cases, each with a specified maximum number of (re-)transmissions of information parts.

According to a second mode of the invention the throughput is expressed in terms of efficiency and bit rate or block rate. When considering, for an efficiency measure, also rate of correct blocks by weighting the throughput in equation (1) by the relative number of blocks indicated to be successfully decoded, SD/(SD+UD), where SD is number of successfully decoded blocks and UD is number of unsuccessfully decoded blocks, the efficiency when considering also unsuccessful decoding would be

$${η}_{2} = \frac{SD {\sum }_{i} {Block}_{i}}{( SD + UD ) {\sum }_{i} ( 1 + {RSN}_{i} )} . \qquad ( 2 )$$

The desired throughput, η, is preferably expressed per time use by dividing the efficiency in equation (2) by time required for each block, T_{block}. To express the throughput in terms of a bit rate rather than a block rate, the efficiency of equation (2) is multiplied by number of bits per block, N_{block},

$$η = \frac{SD \cdot {N}_{block} \cdot {\sum }_{i} {Block}_{i}}{( SD + UD ) \cdot {T}_{block} \cdot {\sum }_{i} ( 1 + {RSN}_{i} )} . \qquad ( 3 )$$

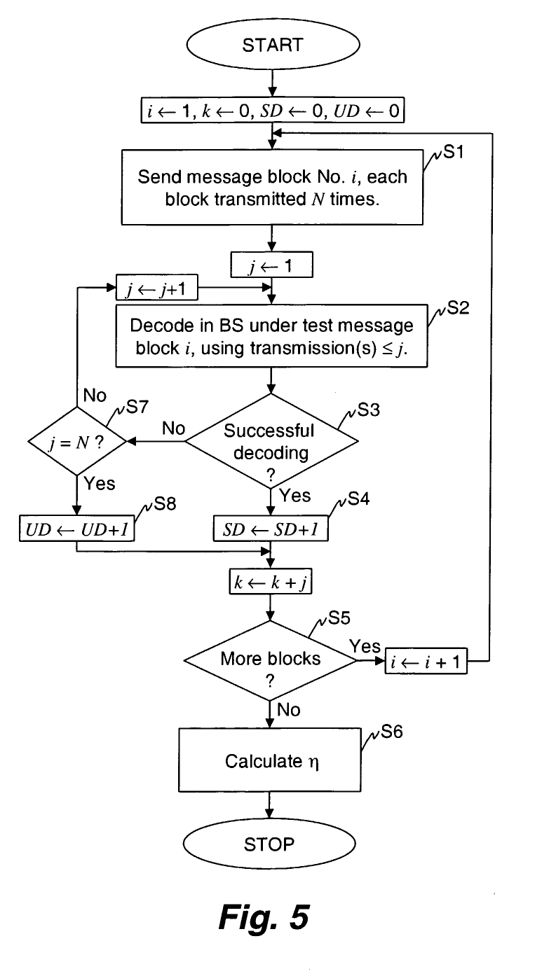

An example test procedure for determining the measure in equation (3) (and correspondingly equation (1) or (2)) is illustrated in the flow chart of FIG. 5.

A predefined number of blocks as checked in step [symbol] S5 [symbol] is to be transmitted in a test. In the test one information block is sent with a maximum number of (re-)transmissions at a time [symbol] S1 [symbol] . The BS under test receives all (re-)transmissions of the message block and decodes the transmitted block [symbol] S2 [symbol] using initially only the first transmission of the message block. It is investigated whether the decoding was successful or not [symbol] S3 [symbol] . In case the decoding was successful, the next message block [symbol] S1 [symbol] is sent (without using the information of the remaining trans-missions of the earlier block) if there are more blocks to send [symbol] S5 [symbol] and optionally the number of successfully decoded blocks is increased by one [symbol] S4 [symbol] . In case the decoding was unsuccessful, it is investigated whether all the maximum number of (re-)transmissions has been considered for decoding. If this is not the case, the base station under test decodes the message block including information in one additional (re-)transmission [symbol] S2 [symbol] . If all (re-)transmissions have been considered when decoding [symbol] S7 [symbol] and no successful decoding has been obtained, optionally the number of unsuccessfully decoded message blocks is increased by one [symbol] S8 [symbol] . When a maximum number of decoding attempts has been reached [symbol] S7 [symbol] or the message block is successfully decoded [symbol] S3 [symbol] , whichever may come first, a next message block is sent, with a maximum number of retransmissions, unless no more blocks are to be investigated according to the test [symbol] S5 [symbol] .

When all message blocks have been sent and decoded, statistics is determined from the variables available. According to current specifications the number of decoding attempts are required to be reported to a higher node, such as a radio network controller, RNC, from a base station. Consequently the total number of required decoding attempts [symbol] S6 [symbol] , k=Σᵢ(1+RSNᵢ), is available output from the BS under test. The number of transmitted information blocks [symbol] S6 [symbol] are known from the test equipment, i=ΣᵢBlockᵢ. Consequently the throughput measure in equation (1) is readily available. Also the transmission time is available for each sent message, T_{block}, and for all messages of a test. The relative number of successfully decoded messages may or may not be available depending on the base station under test. The ratio in equation (2), will consequently be available optionally. In an alternative embodiment the optionally continuously calculated number of successfully decoded number of message blocks are excluded and the rate of successfully decoded message blocks are determined by comparing output data from the base station and data sent.

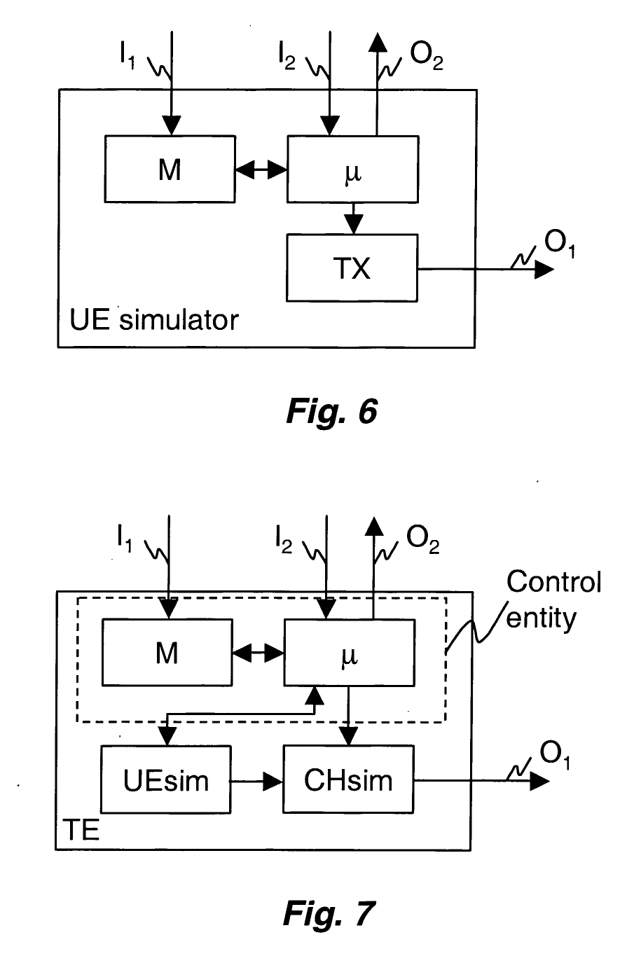

FIG. 6 illustrates a mobile station emulator or simulator [symbol] UE simulator [symbol] according to the invention. The mobile station emulator or simulator [symbol] UE simulator [symbol] comprises preferably storing means [symbol] M [symbol] , processing means [symbol] i [symbol] , and trans-mission circuitry [symbol] TX [symbol] . Predefined one or more maximum number of transmissions per message block is entered into the mobile station emulator or simulator [symbol] UE simulator [symbol] by input means [symbol] I₁ [symbol] , [symbol] I₂ [symbol] . Preferably, the one or more maximum number of transmissions are entered into storing means [symbol] M [symbol] and read out as needed by processing means [symbol] μ [symbol] . Alternatively, individual maximum number of transmissions of message blocks is entered storing means [symbol] M [symbol] or processing means [symbol] μ [symbol] . Processing means [symbol] μ [symbol] is arranged to provide information test messages and the predefined number of retransmissions thereof to the transmission circuitry [symbol] TX [symbol] . The processing means [symbol] μ [symbol] keeps track of number of sent message blocks, preferably including intermediary use of storing means [symbol] M [symbol] . The transmission circuitry outputs modulated one or more signals according to well defined specifications known in the art [symbol] O₁ [symbol] for passage to a base station under test through a channel simulator as described above. When all message blocks have been transmitted the mobile station emulator or simulator provides the number of transmitted message blocks [symbol] O₂ [symbol] . In an example embodiment the mobile station emulator or simulator [symbol] UE simulator [symbol] also provides [symbol] O₂ [symbol] sent data of message blocks from the test case. In the example embodiment, the sent data is compared with received data from the base station under test for evaluation in test equipment as described below.

FIG. 7 illustrates example test equipment [symbol] TE [symbol] according to the invention. The test equipment [symbol] TE [symbol] preferably comprises at least one input [symbol] I₁ [symbol] , [symbol] I₂ [symbol] for inputting maximum number of transmissions of each message block. This could also be stored in storing means [symbol] M [symbol] and accessed as requested by processing means [symbol] μ [symbol] . The test equipment includes a mobile station emulator or simulator [symbol] UEsim [symbol] and a channel simulator [symbol] CHsim [symbol] , where at least the mobile station emulator or simulator [symbol] UEsim [symbol] is controlled by processing means [symbol] μ [symbol] . In a preferred embodiment processing means and storing means are shared between mobile station emulator or simulator [symbol] UEsim [symbol] and test equipment [symbol] TE [symbol] in an integrated entity of test equipment. However, the test equipment could also be realized as a standalone control entity for connection to mobile station emulator or simulator [symbol] UEsim [symbol] and optionally also channel simulator [symbol] CHsim [symbol] . Output from the channel simulator [symbol] O₁ [symbol] is provided to a connector for connection to a base station under test. There are also output means [symbol] O₂ [symbol] for outputting test performance measure for evaluation. Processing means [symbol] μ [symbol] is optionally arranged to also compare data input [symbol] I₁ [symbol] , [symbol] I₂ [symbol] to the test equipment from the output of the base station under test and as provided by mobile station emulator or simulator [symbol] UEsim [symbol] . The test equipment comprises output [symbol] O₂ [symbol] for providing test performance preferably in terms of throughput corresponding to equation (3).

A person skilled in the art readily understands that the receiver and transmitter properties of a BS or a UE are general in nature. The use of concepts such as BS, UE or RNC within this patent application is not intended to limit the invention only to devices associated with these acronyms. It concerns all devices operating correspondingly, or being obvious to adapt thereto by a person skilled in the art, in relation to the invention. As an explicit non-exclusive example the invention relates to mobile stations without subscriber identity module, SIM, as well as user equipment including one or more SIMs. Further, protocols and layers are referred to in close relation with UMTS terminology. However, this does not exclude applicability of the invention in other systems with other protocols and layers of similar functionality.

The invention is not intended to be limited only to the embodiments described in detail above. Changes and modifications may be made without departing from the invention. It covers all modifications within the scope of the following claims.

1. A method for uplink testing of a base station of a mobile communications system, wherein message blocks are each sent with a predefined maximum number of retransmissions from a mobile station emulator or simulator for each message block of the test without requiring one or more retransmission requests from the base station under test.

2. The method according to claim 1 characterized in that the mobile station emulator or simulator and base station are connected via a radio frequency channel simulator.

3. The method according to claim 1 characterized in that the base station under test is designed for hybrid ARQ decoding, combining information of retransmissions.

4. The method according to claim 1 characterized in that there are a predefined number of test cases with different predefined maximum number of retransmissions.

5. The method according to claim 1 characterized in that it can be performed independently of whether a feedback channel is established between the mobile station emulator or simulator and the base station under test.

6. The method according to claim 1 characterized in that it can be performed independently of whether an E-DCH HARQ acknowledgement indicator channel is established between the mobile station emulator or simulator and the base station under test.

7. The method according to claim 1 characterized in that test equipment provides a performance measure in terms of throughput, the performance measure including data from one or more retransmission sequence numbers from the base station under test.

8. The method according to claim 7 characterized in that the maximum number of transmissions of each message block is determined in relation to the representation of the retransmission sequence numbers.

9. The method according to claim 7 characterized in that the maximum number of transmissions of each message block is less than or equal to the greatest value of the representation of retransmission sequence numbers increased by one.

10. The method according to claim 7 characterized in that the performance measure also includes number of transmitted message blocks.

11. The method according to claim 10 characterized in that the performance measure also includes relative number of message blocks successfully decoded by the base station under test.

12. The method according to claim 10 characterized in that the performance measure also includes time use or message block frequency.

13. The method according to claim 1 characterized in that the uplink is enhanced uplink of third generation partnership project.

14. The method according to claim 1 characterized in that the message blocks are sent on an enhanced dedicated channel or an E-DCH dedicated physical data channel.

15. A mobile station emulator or simulator for uplink testing of a base station of a mobile communications system, the mobile station characterized by sending means for sending message blocks a predefined maximum number of times for each message block of the test without requiring reception of one or more retransmission requests from the base station under test.

16. The mobile station according to claim 15 characterized by electric circuitry for varying the predefined maximum number for a predefined number of test cases.

17. The mobile station according to claim 15 characterized by output means for providing number of transmitted message blocks.

18. The mobile station according to claim 15 characterized by output means for providing transmitted information in transmitted message blocks.

19. The mobile station according to claim 15 characterized in that the uplink is enhanced uplink of third generation partnership project.

20. The mobile station according to claim 15 characterized in that the message blocks are sent on an enhanced dedicated channel or an E-DCH dedicated physical data channel.

21. A test equipment for uplink testing of a base station of a mobile communications system, comprising processing means for determining a performance measure associated with message blocks sent from a mobile station emulator or simulator to a base station under test via a channel simulator, each message block being sent with a predefined maximum number of retransmissions for each message block of the test without requiring one or more retransmission requests from the base station under test.

22. The test equipment according to claim 21 characterized by means for radio frequency-interconnecting the mobile station emulator or simulator and the base station under test.

23. The test equipment according to claim 21 characterized in that the test equipment is operative under a predefined number of test cases with different predefined maximum number of retransmissions.

24. The test equipment according to claim 21 characterized in that it is operative independently of whether a feedback channel is established from the base station under test to the mobile station emulator or simulator.

25. The test equipment according to claim 21 characterized in that it is operative independently of whether an E-DCH HARQ acknowledgement indicator channel is established between the mobile station emulator or simulator and the base station under test.

26. The test equipment according to claim 21 characterized by processing means for providing a performance measure in terms of throughput the performance measure including data from one or more retransmission sequence numbers from the base station under test.

27. The method according to claim 26 characterized in that the maximum number of transmissions of each message block is determined in relation to the representation of the retransmission sequence numbers.

28. The method according to claim 26 characterized in that the maximum number of transmissions of each message block is less than or equal to the greatest value of the representation of retransmission sequence numbers increased by one.

29. The test equipment according to claim 26 characterized in that the performance measure also includes number of transmitted message blocks.

30. The test equipment according to claim 29 characterized in that the performance measure also includes relative number of message blocks successfully decoded by the base station under test.

31. The test equipment according to claim 29 characterized in that the performance measure also includes time use or message block frequency.

32. The test equipment according to claim 21 characterized in that the uplink is enhanced uplink of third generation partnership project.

33. The test equipment according to claim 21 characterized in that the message blocks are sent on an enhanced dedicated channel or an E-DCH dedicated physical data channel.

34. A test system characterized by means for carrying out the method in claim 1.

35. (canceled)
